(19) United States
(12) Patent Application Publication
(10) Pub. No.: US 2024/0383218 A1
(43) Pub. Date: Nov. 21, 2024

(54) FEEDING SYSTEM FOR FEEDING POWDER MATERIAL AND SYSTEM FOR CONTINUOUS PRODUCTION OF SOLID DOSAGE FORMS

(71) Applicants: FETTE COMPACTING GmbH, Schwarzenbek (DE); UNIVERSITEIT ANTWERPEN, Prinsstraat 13 (BE)

(72) Inventors: Nicolas Walter, Hamburg (DE); Wouter Grymonpré, Sint-Michiels (BE); Joris Vanderputten, Buizingen (BE); Jozef Verheyen, Mortsel (BE); Jan Vogeleer, Bornem (BE); Serge Tavernier, Antwerpen (BE); Jef Wens, Antwerpen (BE)

(73) Assignees: FETTE COMPACTING GmbH, Schwarzenbek (DE); UNIVERSITEIT ANTWERPEN, Antwerpen (BE)

(21) Appl. No.: 18/690,996

(22) PCT Filed: Sep. 1, 2022
(86) PCT No.: PCT/EP2022/074298

§ 371 Date: Mar. 11, 2024

(30) Foreign Application Priority Data
Sep. 10, 2021 (EP) 21196060.4

(51) Int. Cl. B30B 15/30; B65D 88/66

(52) U.S. Cl. CPC B30B 15/308; B65D 88/66

(57) ABSTRACT

A feeding system for feeding a powder material to a moving powder mass includes a moving device structured to move the powder mass along a movement direction and a feeding reservoir that is structured to provide the powder material to be fed to the moving mass. The feeding reservoir includes a plurality of feeding openings dimensioned for feeding the powder material to the moving powder mass. At least some of the plurality of feeding openings being arranged along the movement direction of the moving powder mass.

### CROSS REFERENCE TO RELATED INVENTION

This application is a national stage application pursuant to 35 U.S.C. § 371 of International Application No. PCT/EP2022/074298, filed on Sep. 1, 2022, which claims priority to, and benefit of, European Patent Application No. 21196060.4, filed Sep. 10, 2021, the entire contents of which are hereby incorporated by reference.

### TECHNOLOGICAL FIELD

The following disclosure pertains to a feeding system for feeding powder material to a moving mass, in particular a moving powder mass, comprising a moving device for moving the powder mass along a movement direction, further comprising a feeding reservoir for providing the powder material to be fed to the moving mass. The disclosure is also directed to a system for continuous production of solid dosage forms.

### BACKGROUND

A system for continuous production of solid dosage forms including a feeding system for feeding powder material to a moving powder mass is known for example from PCT/EP2020/068048. In such systems powder material to be for example compressed in a tablet press to tablets is fed from different inlets usually via different feeding and dosing devices for example to a powder blender in which the powder material is moved along a longitudinal direction of for example a blending tube, usually via a blending screw or the like. Especially in pharmaceutical production different powder materials are blended to produce a powder blend which is subsequently processed for example in a tablet press. The different powder materials can comprise active pharmaceutical ingredients (API), excipients and/or lubricants. The different powder materials can also for example comprise agricultural powders or food powders. Systems explained above are available as batch production systems as well as continuous production systems.

Powder feeding, for example, to a powder blender is challenging, especially when very fine powder materials have to be handled. Fine powder often exhibits strong cohesivity which may impede free flow of the powder material. Feeding or dosing such powder material therefore is difficult. Common issues are bridging, hole formation in a powder bed, hole formation in a feeding stream, or blocking of powder material. These phenomena make continuous dosing of such powder material to another powder material highly challenging. Problems occur in particular since many specific powder materials for the applications in question are very cohesive in nature. However, also common additives, such as stearate salts, exhibit high cohesiveness. Problems are also caused when feeding especially low product quantities, achieve stable and reproducible feeding, and to provide a controllable quantity and/or feed rate in an easy manner.

As explained, the highly precise and highly even feeding of powder material can be of particular importance in the pharmaceutical field. API's become more and more active and also more and more expensive. Therefore, smaller quantities have to be dosed for the product mixture to be processed. The boundary conditions for deviations of the API's per tablet are extremely strict. Typically, a range in relative concentration from only 95% to 105% compared to the ideal 100% is allowed. Further issues are related to the present shift towards continuous manufacturing instead of batch manufacturing, and the desire to allow continuous manufacturing at flexible production speeds. In particular, it is desired to use the same feeding system for small trial productions of e.g. 5.000 tablets per hour up to real industrial production at high speed at e.g. 500.000 tablets per hour. This demands for a high flexibility of the feeding system while at the same time maintaining the requirements with regard to precision and evenness.

In summary, challenges for providing feeding systems of the type in question here lie in the desire to allow for small mass flows of e.g. 5 g/h to 500 g/h, mass flows with a small deviation in mass flow over a very small time frame range of e.g. 95 to 105% for mass flow over time frames of seconds (e.g. 5 sec.), variable mass flow and reduction of cohesiveness of powder material. Further challenges lie in providing feeding systems which allow stable and reproducible feeding over long runs, and which improve the flowability and ease to be admixed of the powder materials. An additional challenge lies in the ease to set up said desired feeding rates of e.g. 5 g/hour to 500g/hour. Additional important criteria are of course costs, contamination issues, cleaning issues, dead volume, run-in behaviour, stability and reproducibility.

Based on the above explained prior art it is therefore an object of the present invention to allow for a large variety of powders, also including highly cohesive powders, to be fed precisely and evenly also for small mass flow ranges and with small variations in adjustable flow rate at low sampling times, and in a stable and reproducible manner over long feeding runs.

### BRIEF SUMMARY OF THE INVENTION

In an embodiment, a feeding system of the above mentioned type the invention solves the above object in that it includes a feeding reservoir that comprises a plurality of feeding openings for feeding the powder material to the moving mass, at least some of said feeding openings being arranged along the movement direction of the moving mass.

In an embodiment of the feeding system according to the invention, a powder material is fed to a moving mass, for example a moving powder mass. The moving mass is moved or transported along a movement direction by a moving device. A feeding reservoir is provided for providing the powder material to be fed to the moving mass. The movement direction of the moving mass can be a linear movement direction, for example a horizontal movement direction. It is of course possible that the moving mass is additionally moved in other directions during movement along the movement direction, for example rotated around the movement direction, for example helically.

According to an embodiment, the feeding reservoir comprises a plurality of feeding openings for feeding the powder material to the moving mass. At least some of said feeding openings, for example all of said feeding openings, are arranged along, in particular parallel to the movement direction of the moving mass. According to the invention, at least some of the feeding openings are thus arranged to provide a line feeding of the powder material to the moving mass along a line which corresponds to the movement direction of the moving mass. The powder material is thus fed to the moving mass along an elongate pattern, like a line, having a greater dimension or elongation along a first direction than along a second direction, in particular a second direction being perpendicular to the first direction. The first direction can correspond to the movement direction of the moving mass. According to the invention, the powder material can be fed from the feeding openings directly to the moving mass. It is possible that there is no intermediate component between the feeding openings and the moving mass, particularly no intermediate component, like a funnel, that causes a (re-) agglomeration of the powder material before reaching the moving powder mass. It is advantageous that the elongate pattern, like a line, along which the powder material is exiting the feeding openings is not condensed or shortened again to a less elongate pattern, in particular not to a feeding point, for example by an intermediate component like a funnel, before being fed to the moving mass. Rather, the powder material reaches the moving mass in the form of the elongate feeding pattern, in particular the feeding line.

The feeding reservoir can, for example, comprise more than 5, more than 10, or more than 20 feeding openings arranged along the movement direction of the moving mass. If the moving mass is for example transported within a tube, such as a blending tube of a powder blender, the movement direction as well as the line along which at least some of the feeding openings are arranged, can for example correspond to the longitudinal axis of the tube. Powder material can fall through the feeding openings onto the moving mass being moved for example below the feeding reservoir with its feeding openings. The powder material can thus fall through the feeding openings via gravity. The feeding of the powder material through the feeding openings can also be supported by further measures, such as feeding or deagglomerating devices. The moving device may also comprise a conduit arranged with inclination towards the horizontal line for moving the powder mass, for example via gravity or via a vibrating inclined channel. The moving device may also comprise a conduit arranged along a horizontal line, wherein the powder mass is moved by a moving device, for example a blending screw of a blender.

Prior art feeding systems are single point feeders, meaning that the powder material is fed to the moving mass essentially at a point. In particular, in prior art feeding systems no line feeding along the movement direction of the moving mass is provided. In such prior art systems, any time variations in the feeding rate of the powder material to the moving mass will be converted into spatial variations in the product stream of the moving mass with the fed powder material. This leads to, for example, a blender having to effect a high redistribution and thus blending of the material to obtain a homogeneous mixture. By providing feeding openings along a line, i.e. an assembly of several feeding points along the movement direction of the moving mass according to the invention, a specific volume of powder in the moved powder mass will collect powder material fed by different feeding openings along the movement direction. Variations in the feeding rate of the powder material are thus evened out. For example, a temporary, even only partial, blocking of one of the feeding openings will only have a small effect with regard to the overall fed powder material since powder material will still be fed via the feeding openings not blocked. The invention thereby achieves a time based and spatial averaging of the feeding process which leads to a particularly even and constant overall feed rate to the moving mass, also for difficult powder materials, such as powder materials with a high cohesiveness.

Usually, the powder material to be fed to the moving mass has a much smaller mass compared to the moving mass, for example more than 10 times smaller powder mass. The invention ensures an improved distribution of the powder material, being usually the minor ingredient, in the moving mass, being usually the major ingredient, in the overall powder mixture. This is achieved by distributing the powder material over and into a wide volume of the moving mass, already during the feeding process. A potentially subsequent blending process for blending the powder material with the moving mass can thereby start from an already better distributed powder mass. The powder mixture to be processed further for example in a tablet press is thus of higher quality. A mass flow can thus be fed with high precision also on short time scales/short sampling times, for example sampling times in the range of 1 to 25 sec., more specifically 1 to 10 sec. The invention allows for very small mass flows of the powder material to be fed to the moving mass of for example less than 500 g/h, in particular as low as 5 g/h. At the same time, a wide range of mass flows can be realized at high feeding accuracy and evenness, for example in a range of 5 g/h to 2 kg/h.

The feeding openings can be arranged close to one another, for example have a distance seen in the movement direction of less than 2 cm, preferably less than 1 cm. The openings may further have a small cross-section, of for example less than 10 mm, preferably less than 5 mm. If the feedings openings are circular, the cross-section may be the diameter of the openings.

According to an embodiment, the feeding openings may be arranged above at least one inlet of the moving device such that the powder material can be fed through the feeding openings to the moving mass via gravity. This embodiment, already explained above, is particularly practical. Other possible embodiments would include feeding powder material to the moving mass with for example air assistance, for example with small directed streams of air oriented downwards, to avoid powder sticking to walls the powder material comes into contact, and/or to accelerate the powder curtain so as to ensure deeper penetration into the moving mass. Such small directed streams of air can be generated with technology known to the skilled person per se, for example with air blow holes, air nozzles, or air knives.

According to a further embodiment, also already generally explained, more than two feeding openings of the feeding reservoir may be arranged along a line along the movement direction of the moving mass, for example more than 5 feeding openings, preferably more than 10 feeding openings, more preferably more than 20 feeding openings. Generally, a higher number of feeding openings improves the evening out of the powder material feeding to the moving mass.

According to a further embodiment, at least some of the feeding openings may further be arranged along a direction angled, in particular transverse, to the movement direction of the moving mass. Thereby, a two-dimensional arrangement of feeding openings can be arranged, which may further improve the feeding of the powder material to the powder mass.

Possible feeding opening patterns are for example multiple lines in parallel, each line oriented parallel to the movement direction of the moving mass, or other two-dimensional patterns, for example a screen or mesh pattern. Such a screen could also be flexible. This may help the feeding process, also with regard to a response to possible vibrations. Generally, for example an underside of the feeding reservoir provided with the feeding openings may be a flat side, or a three-dimensionally shaped underside, for example a cylindrically shaped underside. Consequently, the feeding openings can also be arranged along a three-dimensional area.

The feeding reservoir may comprise feeding openings being arranged at an underside of the feeding reservoir, as also already explained. For example, the feeding reservoir may comprise a feeding conduit with the feeding openings at its underside. The feeding conduit can for example have a cylindrical shape, with the cylinder axis arranged parallel to the movement direction of the moving mass, for example horizontally.

According to a further embodiment, the feeding reservoir may comprise a mechanical interaction device for mechanically interacting with the powder material before feeding it to the moving mass, in particular a mechanical deagglomerating device for mechanically deagglomerating the powder material before feeding it to the moving mass. Such a mechanical interaction device can further improve flowability and thus feeding of the powder material to the moving mass. In particular, such an interaction device can help to break up structures like bridges. The interaction device can for example act directly on or at the plurality of feeding openings to at least downsize agglomerates of powder material directly before feeding it to the moving mass.

The mechanical interaction device may also induce (active) transport of the powder material before or during feeding it to the moving mass. The device can for example push the powder material through the feeding openings. In this way the dosing of the powder material can be controlled. The device can thus have a metering function even in case no active push is exerted.

According to a particularly practical embodiment, the mechanical interaction device may comprise a rotating element arranged in the feeding reservoir. Such a rotating element may for example pass in close vicinity to the line of feeding openings and thus act as an actuator to these openings, metering the amount of powder material fed through the openings. Different embodiments for such a rotating actuator are possible, as will be explained below. For example, a paddle wheel, a screw or a brush. The metering of the powder material can be passive, essentially by opening and closing the feeding openings during rotation of the rotating element, or active such that the powder material is actively pushed through the feeding openings by the rotating element. To this end the powder material may be forced to move along the area with the feeding openings and pressure may be exerted by the rotating element to the flow of powder material such that a pressure, for example a lateral pressure, pushes the powder material through the feeding openings. The rotating member may rotate in close vicinity to the feeding openings, as explained, or even in contact with the feeding openings, in particular if the rotating element has sufficient flexibility. The feeding reservoir may comprise two side plates thus providing a construction to allow mounting of the rotating element in the feeding reservoir between the side plates. Two further side plates may together with the first two side plates form a trough-like powder reservoir, said reservoir provided for example at its bottom side with the feeding openings. As already mentioned, the rotating element can be rigid or have flexibility. Generally, rotation of the rotating element can be clockwise or counter-clockwise. It can be unidirectional or oscillatory in direction. It can also be continuous or intermittent. The speed of rotation can also be controlled in a suitable manner to control the dosing of the powder material through the feeding openings. In this way a tuneable feeding system can be provided with the rotating element serving as a tuneable or controllable metering device to easily control the feeding rate. To this end a corresponding control device can be provided.

According to a preferred embodiment, the rotating element may be a rotating brush. A rotating axis of the rotating brush may be essentially aligned with the movement direction of the moving mass or with the line of feeding openings. Such a rotating brush provides for a particularly efficient deagglomeration of the powder material. The brush can be twined. The brush may have an axis from twisted metal wiring. Material for the bristles can be for example natural fibre, synthetic fibre, metal fibre. The brush can also be a core with bristles arranged on the core. The brush can be full or can be provided with bristle dense portions and bristle less dense portions. It can also have portions without bristles, i.e. open spaces. The bristle density can be cylindrically symmetric or random or spiral. Bristles can be arranged for example in parallel rows along the rotational axis of the brush, in staggered rows or in angled rows. The bristles can also have a random row arrangement, in particular in high density brushes. The stiffness of the bristles can also be tuned according to the particular demands. The same applies to the length and/or diameter of the bristles. To this end, a suitable design can be chosen with regard to saturation of the brush with powder material at the start-up of a feeding process. A brush with a larger core, i.e. a core with a larger cross section, in particular diameter, and shorter bristles will saturate quicker, which is generally desired, but exhibits higher stiffness. Further parameters for choosing the particular brush design are for example stiffness control or antistatic control. If lower stiffness is desired, the core may be designed to be smaller and the bristles longer. Bristles of the rotating brush may be in contact with inner walls of the feeding reservoir, in particular an inner wall provided with the feeding openings. The bristles can thus be slightly bent when in contact with the inner walls. Generally, due to the provision of bristles on a rotating brush the impact on the powder material coming in contact with the brush upon rotation is not homogenous. The impact will be large on the bristle portions and there will be almost no impact in the spaces between the bristles. This results in a particularly efficient deagglomeration of the powder material since the powder material is vertically cut in small sections. The bristles thus perform a cutting action to the powder material. The small sections of powder material can easily be fed through the feeding openings to the moving mass. This deagglomerated state of the powder material is also ideal for further dispersion in a blender blending the moving mass together with the powder material fed through the feeding openings.

According to a further embodiment, the rotating brush may comprise flexible bristles contacting an inner wall of the feeding reservoir comprising the feeding openings during rotation of the brush, wherein at least some of the flexible bristles enter and exit the feeding openings during rotation. The bristles are slightly bent when in contact with the inner wall. Upon arriving during rotation at one of the feeding openings the respective bristles are straightened again in the areas where the inner wall is not present. In this way the bristles will make sure that none of the feeding openings are clogged. In addition, a particularly efficient deagglomeration is achieved since the bristles, due to their elasticity and tension build-up by sliding along an inner wall, will deagglomerate and actively push powder material through the feeding openings when temporarily readopting their relaxed form when entering a feeding opening. Of course, it would also be possible that the bristles do not enter the feeding openings. It would also be possible that the bristles do not contact an inner wall of the feeding reservoir, in particular the inner wall provided with the feeding openings, which would allow a particularly rigid brush and bristles with a correspondingly strong deagglomeration function. As already explained, the bristles of the brush may be different in size, number and/or pattern, optimized for a specific cohesive powder material. The size, number and/or pattern of the bristles may for example be larger than the feeding openings, to induce a high shear onto the powder material between the brush and the feeding openings, so as to force the powder through the openings. This may be advantageous to induce powder flow through the feeding openings. The bristles may also be provided with smaller size, number and/or pattern than the feeding openings, whereby the bristles slide against the wall provided with the feeding openings, thereby creating a vibration of the feeding reservoir at the feeding opening. This may be advantages to induce powder flow through the feeding openings as well. As already explained, the rotating element could also be provided in a different form, for example be a rotating fixed paddle element.

For further improving flow of the powder material the feeding reservoir may comprise flow aid means for aiding the flow of the powder material to be fed to the moving mass to the feeding openings.

The flow aid means may comprise at least one powder agitator. The at least one powder agitator may for example comprise at least one movable paddle and a drive for moving the movable paddle in the powder material, for example laterally moving the powder paddle back and forth, before feeding the powder material to the moving mass. Such a powder agitator may preferably be arranged upstream of a rotating element in the feeding reservoir. A preferred embodiment of such a powder agitator may be a plurality of (small) movable paddles. The moveable paddles may be reciprocating or oscillating along a linear movement direction in particular to break up powder bridges. A powder agitator may also comprise for example a conveying screw and/or a vibrating device for vibrating the feeding reservoir and/or at least one fork for conveying the powder material. For example, a vibrating device for vibrating the feeding reservoir may comprise an ultrasonic vibrating device. Such vibration further improves flowability of the powder material.

Powder movement, i.e. sliding against confining walls of the feeding reservoir can also be improved by specific surface treatment of the walls. The said walls may be treated by abrasive blasting and shot peening, in particular micro shot peening, preferably using a suspension comprising a liquid and a mixture of spherical and irregular shaped abrasive particles. The surface treatment can thus be done by abrasive blasting and micro shot peening at the same time, preferably using a suspension comprising a liquid and a mixture of both spherical and irregular shaped particles. By using an abrasive blasting and micro shot peening at the same time using a suspension comprising a liquid and a mixture of at least two different types of abrasive particles, powder flow is improved even further, by further reduction of powder adhesion with surface improvements of a conventional shot peening such as closure of micro-fissures and micro-perforations, but without the disadvantageous surface deformation and surface stresses induced by conventional shot peening. The surface treatment may further be done by abrasive blasting and micro shot peening at the same time using a suspension comprising a liquid and a mixture of at least two different types of abrasive particles, whereby both spherical and irregular shaped particles are used. This further improves flowability within the feeding device.

A vibrating device can further be provided upstream of the feeding openings. The material to be fed can for example be provided by a hopper and/or funnel. The material then falls into the feeding device. If for example a funnel or hopper is provided between the feeding openings and the moving mass this funnel or hopper may be provided with a vibrating device for vibrating the funnel or hopper. Of course the same can apply to a duct that can be present between the bottom of the feeding device with the holes and the moving mass flow.

According to a further embodiment, an ionizing device may be provided downstream of the plurality of feeding openings and before feeding the powder material to the moving mass. Ionization of the material after leaving the feeding openings in plane air before entering the moving mass can be done in order to neutralize or at least reduce the electrical charge of the powder. Also ionization of the powder material for example in a connecting conduit connecting the feeding openings with a conduit transporting the moving mass, may be utilized to neutralize or reduce a potential electrical charge of the powder material particles. In this manner problems associated with so-called internal repulsion of the powder material and/or electrical adhesion of charged powder to surfaces in general can be avoided.

According to a further embodiment, the moving device may comprise a blending device for blending the powder material fed to the moving mass with the moving mass. Such a blending device may for example comprise a blending tube in which the moving mass is moved, for example by a blending screw, while at same time being blended with the powder material fed through the feeding openings into one or more inlets of the blending tube. The blending device may comprise blending means for moving the powder mass and at the same time blending the powder material fed to the moving mass with the moving mass. The blending means may comprise for example at least one rotating blending screw as explained. The blending device may be a dry powder blender, in particular a continuous dry powder blender. The moving mass inside the blending device may be a moving powder bed, it may also be an aerated powder-bed. The blending device may also be part of a granulator, in particular the first section, i.e. the blending section, of a granulator. The blending device may be part of a dry agglomerator, a dry aggregator, a dry granulator, potentially with small liquid additions, like a moisture activated dry granulation process. The blending device may also be part of a wet granulator or a hot-melt extruder, in particular a continuous wet granulator or a continuous hot-melt extruder. The moving mass may thus be a moving powder mass or a different moving mass, such as a moving fluid mass, like for example a molten plastic mass or a moving slurry like mass. These more fluid mass related systems correspond for example to the application for colouring a molten plastic mass or the addition of nutrient to feed material for animals in e.g. agricultural applications or the like. As already explained, the moving mass may be moved along a slope with an inclination to the horizontal direction. The moving device may also be a device upstream of a blending device, in particular feeding the moving mass with the powder material fed through the feeding openings to a downstream blending device. Parts of the moving device and/or the blending device may also be provided with a vibrating device. Generally, moving devices may also comprise dense phase vacuum product conveying devices, powder pumps, such as powder membrane pumps, disc conveyors, or powder transport belts, in each case potentially followed by a blending device. The moving device may further comprise a funnel or a hopper.

According to a further embodiment, the moving device may also comprise a fluidizing device for fluidizing the moving mass. Such fluidizing may for example be effected by introducing air, thus providing aeration, as already explained.

The feeding system may be a continuous feeding system for continuously feeding the powder material to the moving mass. As explained initially, such continuous systems are used more and more while at the same time posing specific challenges with regard to the feeding of certain powder materials. The feeding system may, however, also be a semi-continuous or non-continuous system. It could for example provide intermittent feeding, forward feeding, backward feeding, tuned feeding, for example with adapted feeding speed.

The invention also solves the above explained object with a system for continuous production of solid dosage forms in direct processing, comprising an inventive feeding system, wherein the feeding system comprises an outlet for the moving mass with the powder material fed to the moving mass, further comprising a production machine, preferably a tablet press or a capsule filling machine, comprising a production machine inlet being connected with the outlet of the feeding system, and comprising a production machine outlet for solid dosage forms produced in the production machine.

A method for feeding powder material to a moving mass, in particular a moving powder mass, is provided wherein the moving mass is transported along a movement direction, wherein the powder material to be fed to the moving mass is provided to a feeding reservoir and fed to the moving mass through a plurality of feeding openings of the feeding reservoir, at least some of said feeding openings being arranged along the movement direction of the moving mass. The powder material may be continuously fed to the moving mass, as explained. As also explained, the powder material may also be fed to the moving mass non-continuously or semi-continuously or intermittently.

In an embodiment of the inventive method, the moving mass with the powder material fed to the moving mass may further be fed continuously to a production machine, preferably a tablet press or a capsule filling machine, for continuous production of solid dosage forms in direct processing, for example tablets or capsules.

The inventive method can be carried out with the inventive feeding system and/or the inventive system for continuous production of solid dosage forms. Consequently, the inventive system as well as the system for continuous production of solid dosage forms may be designed to carry out the inventive method.

### BRIEF DESCRIPTION OF THE DRAWINGS

Embodiments of the invention will be explained in more detail below with reference to the drawings.

FIG. 1 schematically illustrates an embodiment of a system for continuous processing of solid dosage forms in direct processing.

FIG. 2 is a detailed perspective view of a portion of the system shown in FIG. 1.

FIG. 3 illustrates an enlarged perspective view of an embodiment of a feeding system of embodiment of FIG. 2.

FIG. 4 illustrates another perspective view of the embodiment of the feeding system shown in FIG. 3.

FIG. 5 illustrates the embodiment of the feeding system shown in FIG. 3 with a front wall removed.

FIG. 6 illustrates a further embodiment of the feeding system shown FIG. 5.

FIG. 7 illustrates a perspective view of an embodiment of a brush for the embodiment of the feeding system shown in FIG. 3.

FIG. 8 illustrates a perspective view of another embodiment of a brush for the embodiment of the feeding system shown in FIG. 3.

FIG. 9 illustrates a perspective view of another embodiment of a brush for the embodiment of the feeding system shown in FIG. 3.

FIG. 10 illustrates a perspective view of a further embodiment of a brush for the embodiment of the feeding system shown in FIG. 3.

In the drawings the same reference numerals shall denote the same components.

### DETAILED DESCRIPTION OF THE INVENTION

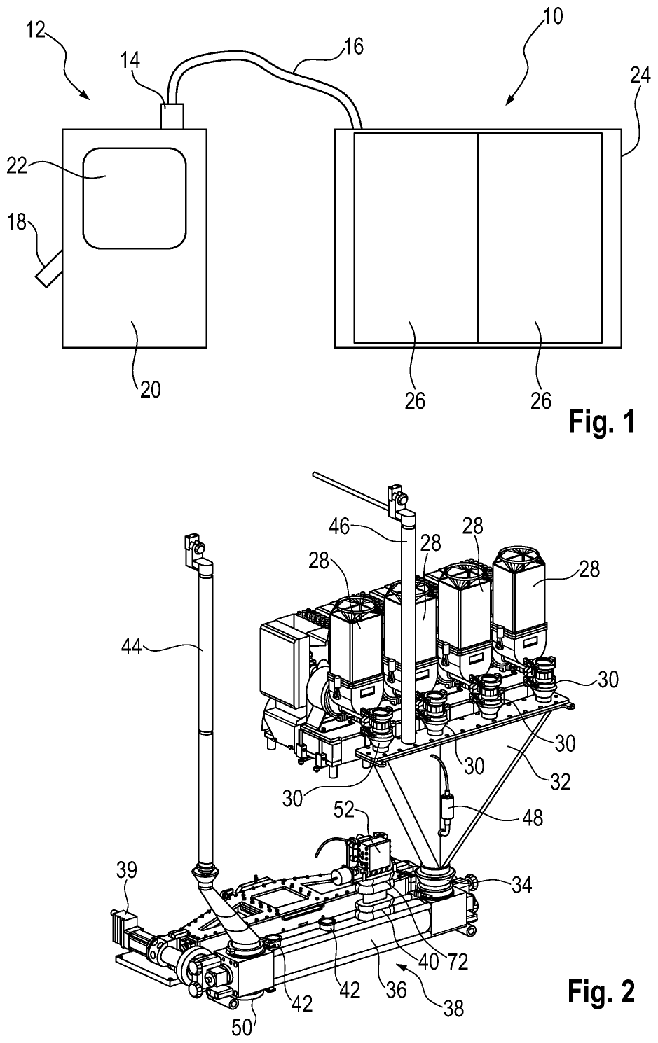

An embodiment of a system for continuous production of solid dosage forms in direct processing is shown in FIG. 1 and comprises a feeding and blending system 10 and a production machine 12, for example a tablet press, such as a rotary tablet press, or a capsule filling machine. The production machine 12 comprises an inlet 14 which is connected with a duct 16 of a product conveying device conveying a product mixture from the feeding and blending system 10 to the inlet 14 of the production machine 12, where the product mixture is continuously processed to solid dosage forms, such as tablets or capsules. The produced solid dosage forms are discharged via an outlet 18 of the production machine 12. The production machine 12 comprises a housing 20 with a window 22. The feeding and blending system 10 comprise a system housing 24 with two doors 26 which may be opened to access the internal components. The system shown in FIG. 1 is a one floor arrangement where the feeding and blending system 10 and the production machine 12 are provided on the same level, in particular the same floor level.

The system shown in FIG. 1 comprises a plurality of inlets at the top of the system housing 24 of the feeding and blending system 10. Referring to FIG. 2, the inlets are connected with a plurality of feeders 28 which are connected with inlets 30 of a funnel 32, said funnel 32 with its lower side opening being connected with an inlet 34 of a blending tube 36 of a blending device 38, said blending device 38 being a moving device 38 for moving the powder mass fed by the feeders 28 via funnel 32 along the longitudinal direction of the blending tube 36 while at the same time blending the powder mass. To this end, at least one blending screw can be arranged in the blending tube 36, said blending screw being rotated by at least one drive 39. The blending tube 36 in the example shown is arranged along a horizontal line and comprises further inlets 40, 42 at its upper side. Venting tubes 44, 46 are connected with the blending tube 36 and the funnel 32, respectively. The feeders 28 may feed different powder materials to the funnel 32 and thus to the blending tube 36, for example different excipients and/or lubricants and/or API's. The funnel 32 also comprises a vibrating device 48, in particular an ultrasonic vibrating device 48 to improve flowability of the powder materials inside the funnel 32 and to avoid accumulation of product on walls of the funnel 32. An outlet 50 of the blending tube 36 is connected with the duct 16 of the product conveying device for conveying a product mixture provided at the outlet 50 of the blending tube 36 to the production machine 12 for further processing, as explained above.

In FIG. 2, an inventive feeding system 52 for feeding powder material to the moving powder mass inside the blending tube 36 is connected with the further blender inlet 40. Through this feeding system for example an API can be fed to the moving powder mass inside the blending tube 36.

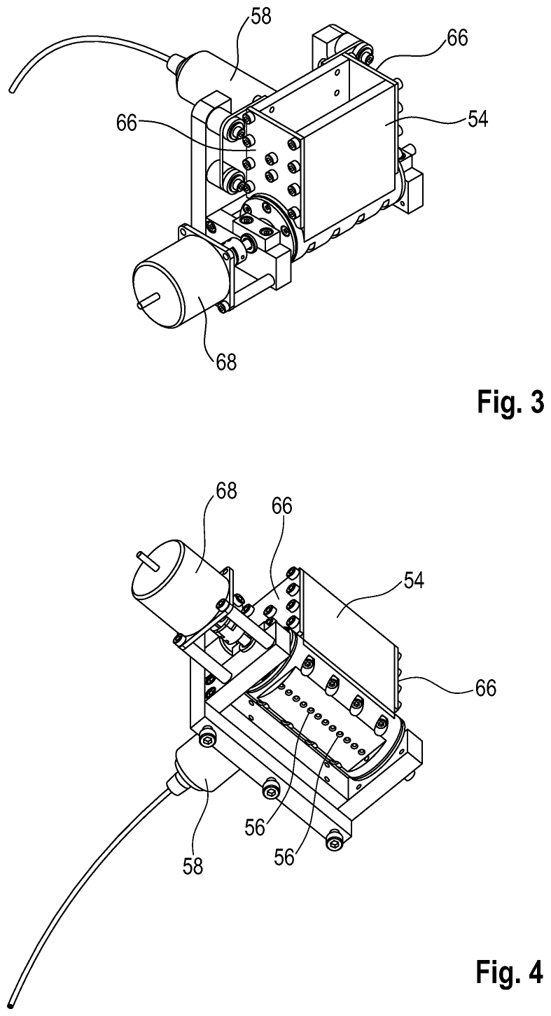

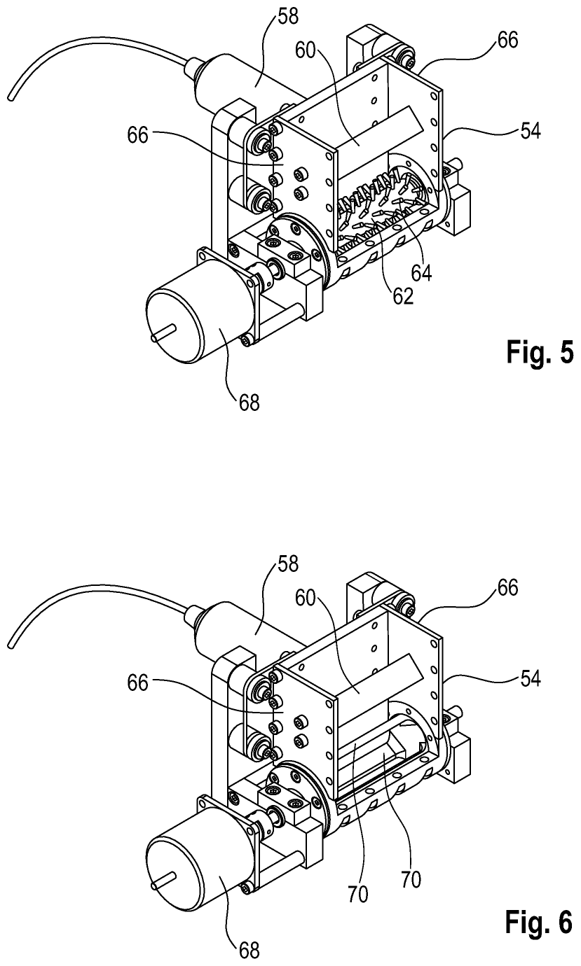

The feeding system 52 will be explained in more detail with reference to FIGS. 3 to 6. The feeding system 52 comprises a feeding reservoir 54 containing the powder material to be fed to the blending device 38 via inlet 40. The upper side of the feeding reservoir 54 can be connected with for example a hopper or feeder for feeding further powder material to the feeding reservoir 54 as required. As can be seen in FIG. 4 the underside of the feeding reservoir 54 is provided with a plurality of feeding openings 56 arranged along a horizontal line which is arranged along the movement direction of the moving powder mass, which again corresponds to the longitudinal axis of the blending tube 36. The powder material contained in the feeding reservoir 54 thereby falls mainly via gravity through the feeding openings 56 and the inlet 40 into the blending tube 36 and onto the moving powder bed inside the blending tube 36. In the further process the powder material is blended with the moving powder mass inside the blending tube 36 through the blending screw or the like. The feeding system 52 also comprises a vibrating device 58, for example an ultrasonic vibrating device 58, for vibrating the feeding reservoir 54 and thus to improve flowability of the powder material. As can be seen in the view of FIG. 5, where a front wall of the feeding reservoir 54 is omitted for better understanding, inside the feeding reservoir 54 a deflecting shield 60 is provided and underneath the deflecting shield 60 a rotating brush 62 with a plurality of bristles 64 is arranged inside the feeding reservoir 54 such that during rotation of the brush 62 at least some of the bristles 64 are in contact with the underside of the feeding reservoir 54 comprising the feeding openings 56, and in fact some of the bristles 64 enter and leave the feeding holes 56 during rotation. The rotating brush 62 is arranged between two side plates 66 of the feeding reservoir 54. A drive 68 is provided for rotating the brush 62 in operation. The rotating brush 62 forms a mechanical interaction device 62 for mechanically interacting with the powder material before feeding it to the moving powder mass through the feeding openings 56. To this end, the bristles 64 are flexible.

FIG. 6 shows a further embodiment which only differs from the embodiment shown in FIGS. 3 to 5 with regard to the mechanical interaction device. More specifically, instead of the rotating brush 62, in FIG. 6 a rotating device with fixed paddles 70 is provided as a mechanical interaction device. Again, the rotating device is rotated by drive 68 during rotation. During this rotation the fixed paddles 70 rotate past the feeding openings 56 and in close vicinity to the feeding openings 56. In this manner, also the rotating device of FIG. 6 deagglomerates the powder material before feeding it through the feeding openings 56.

In addition, for example an ionizing device, in particular an ionizing plate, may be provided and incorporated into an outlet 72 of the inventive feeding system 52, as shown in FIG. 2. Such an ionizing device may serve to neutralize a possible electric charge of the powder material downstream of the plurality of feeding openings 56 and before feeding it to the moving powder mass through inlet 40 of the blender tube 36, as explained above.

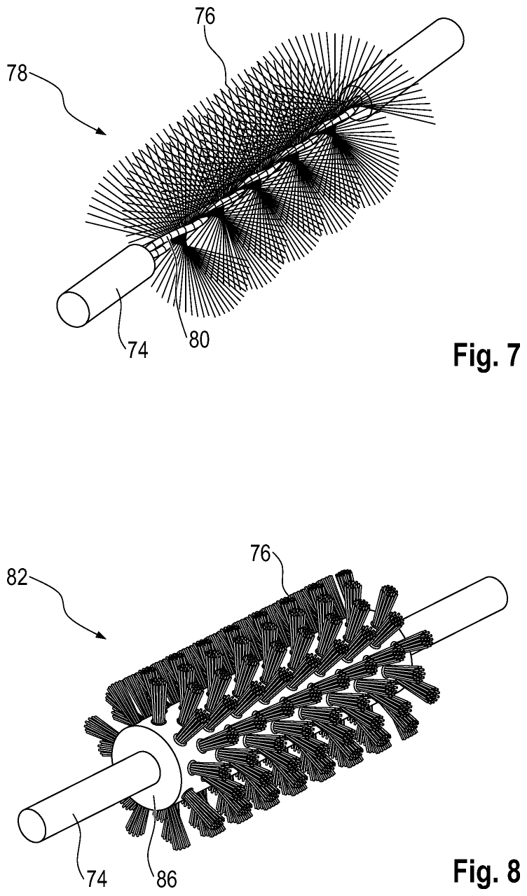

FIGS. 7 to 10 show different embodiments for brushes which can be used in the inventive feeding system. Each of the brushes has a cylindrical axis 74 with which the brush can be fixed to a rotating drive to rotate the brush during operation. Furthermore, each brush has bristles 76 fixed to a centre part. The brushes shown in FIGS. 7 to 10 differ with regard to the embodiment and arrangement of the bristles and the embodiment of the centre part, as will be explained in the following. Generally, the material of the bristles can be natural fibre, synthetic fibre, metal fibre or the like.

The brush 78 shown in FIG. 7 is a twined brush with a centre part formed by twisted metal wiring 80 to which the bristles 76 are fixed from which a twined arrangement of the bristles 76 results.

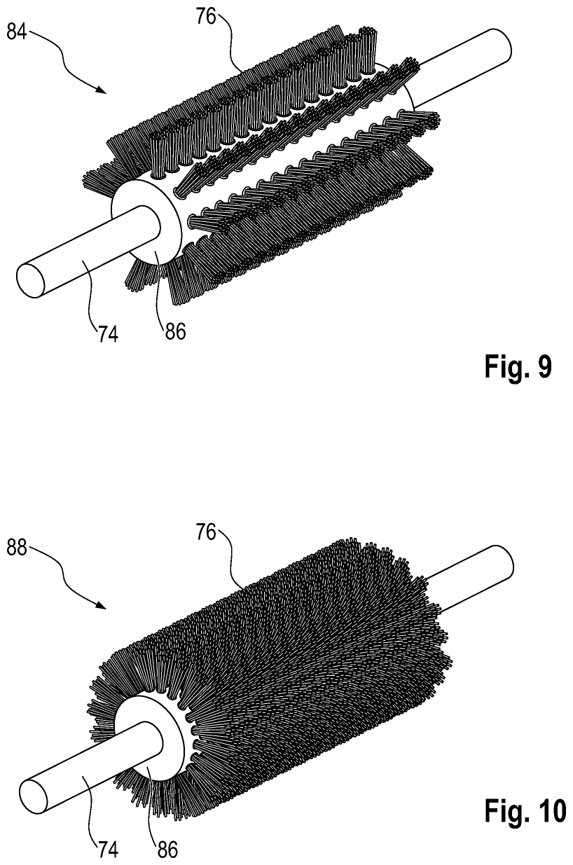

The brushes 82 and 84 shown in FIGS. 8 and 9 have a solid centre part 86 with holes into which the bristles 76 are implanted. The centre part 86 has a larger diameter than the centre part of the brush 78 shown in FIG. 7. The bristles 76 of the brushes 82 and 84, on the other hand, are shorter than the bristles 76 of the brush 78. According to the arrangement of the holes in the centre part 86 different bristle patterns can be realised, for example a full staggered pattern, like in FIG. 8, or a less dense row pattern, like in FIG. 9.

The brush 88 shown in FIG. 10 has a centre part 86 corresponding to the centre part 86 of the brushes 82 and 84. Also the length of the bristles 76 is similar. However, compared to the brushes 82 and 84, the bristles 76 of brush 88 are provided in a higher density and in a randomized arrangement.

Depending on the embodiment and arrangement of the bristles and the centre parts it is possible to adjust the stiffness, antistatic properties and saturation of the brushes in the manner desired for the specific application. To this end, not only the design of the centre part and the length and arrangement of the bristles can be adapted, but also for example the type of bristle material (bristle fibre) and the diameter of the bristles, depending on the desired purpose.

### LIST OF REFERENCE NUMERALS

10 feeding and blending system
12 production machine
14 inlet
16 duct
18 outlet
20 housing
22 window
24 system housing
26 doors
28 feeders
30 inlets
32 funnel
34 inlet
36 blending tube
38 blending device
39 drive
40 inlet
42 inlet
44 venting tube
46 venting tube
48 vibrating device
50 outlet
52 feeding system
54 feeding reservoir
56 feeding openings
58 vibrating device
60 deflecting shield
62 rotating brush
64 bristles
66 side plates
68 drive
70 fixed paddles
72 outlet
74 cylindrical axis
76 bristles
78 brush
80 centre part
82 brush
84 brush
86 centre part
88 brush

1-18. (canceled)

19. A feeding system for feeding a powder material to a moving powder mass comprising:
a moving device configured to move the powder mass along a movement direction; and
a feeding reservoir configured to provide the powder material to be fed to the moving mass, the feeding reservoir comprises,
a plurality of feeding openings dimensioned for feeding the powder material to the moving powder mass, wherein at least some of the plurality of feeding openings are arranged along the movement direction of the moving powder mass.

20. The feeding system according to claim 19, wherein the plurality of feeding openings are arranged above at least one inlet of the moving device, and wherein the powder material is fed through the plurality of feeding openings into the moving powder mass.

21. The feeding system according to claim 19, wherein the feeding reservoir comprises more than two feeding openings arranged along a line following the direction of the movement of the moving powder mass.

22. The feeding system according to claim 19, wherein at least some of the plurality of the feeding openings are arranged along an axis that intersects the movement direction of the moving powder mass.

23. The feeding system according to claim 19, wherein the feeding reservoir further comprises a mechanical interaction device configured to mechanically interact with the powder material before feeding the powder material to the moving powder mass.

24. The feeding system according to claim 23, wherein the mechanical interaction device comprises a rotating element arranged in the feeding reservoir.

25. The feeding system according to claim 24, wherein the rotating element rotates in at least one of: (i) a single direction; (ii) an oscillating manner; (iii) a continuous manner; and (iv) an intermittent manner.

26. The feeding system according to claim 24, wherein a speed of the rotating element is configured to be adjusted in order to control a feeding rate of the powder material to the moving powder mass.

27. The feeding system according to claim 24, wherein the rotating element comprises a rotating brush.

28. The feeding system according to claim 27, wherein the rotating brush comprises flexible bristles, wherein during a rotation of the rotating brush, the flexible bristled contact an inner wall of the feeding reservoir that comprises the plurality of feeding openings, and wherein at least some of the flexible bristles enter and exit the plurality of feeding openings during the rotation of the rotating brush.

29. The feeding system according to claim 19, wherein the feeding reservoir further comprises a flow aid configured to aid a flow of the powder material to the plurality of feeding openings.

30. The feeding system according to claim 29, wherein the flow aid comprises:
at least one movable paddle; and
a drive configured to move the movable paddle in the powder material before feeding the powder material to the moving powder mass.

31. The feeding system according to claim 29, wherein the flow aid comprises a vibrating device configured to vibrate the feeding reservoir.

32. The feeding system according to claim 19, further comprising an ionizing device positioned downstream of the plurality of feeding openings and before the powder material is fed into the moving powder mass.

33. The feeding system according to claim 19, wherein the moving device comprises a blending device configured to blend the powder material with the moving powder mass.

34. The feeding system according to claim 19, further comprising a fluidizing device configured to fluidizing the moving powder mass.

35. The feeding system according to claim 19, wherein the feeding system is a continuous feeding system configured to continuously feed the powder material to the moving powder mass.

36. A system for continuous production of solid dosage forms in direct processing, comprising the feeding system according to claim 19, wherein the system comprises:
an outlet for the moving powder mass including the powder material;
a production machine comprising a production machine inlet connected with the outlet of the feeding system; and
a production machine outlet configured to output solid dosage forms produced in the production machine.
